(19) United States
(12) Patent Application Publication
(10) Pub. No.: US 2019/0343129 A1
(43) Pub. Date: Nov. 14, 2019

(54) LOAF PAN

(71) Applicant: Marc-Hamid ELSEN, Wuppertal (DE)

(72) Inventor: Ralf SCHEEL, Wuppertal (DE)

(21) Appl. No.: 16/348,971

(22) PCT Filed: Nov. 22, 2017
(86) PCT No.: PCT/DE2017/101009

§ 371 Date: Jul. 19, 2019

(30) Foreign Application Priority Data
Nov. 30, 2016 (DE) 10 2016 123 167.3

(51) Int. Cl. A21B 3/13; A47J 37/01; A47J 36/04

(52) U.S. Cl. CPC A21B 3/138; A47J 36/04; A47J 37/01; A21B 3/131

(57) ABSTRACT

The invention relates to a pan (10, 12) for holding food, in particular for baking or cooking, comprising a plurality of side walls (34a, 34b, 35a, 35b) and a floor (33). The invention is characterized in that the pan is formed from a flat mat (11) made of a high-temperature-resistant, elastic, flexible silicone rubber or another plastic, the mat (11) comprising at least one floor panel (13b) and a plurality of side-wall panels (13a, 13c, 13k, 13f) oriented parallel thereto, wherein there is between the floor panel and each side-wall panel an in particular straight predetermined fold line (14a, 14b, 15a, 15b) along which the side-wall panel (13a, 13c, 13k, 13f) can be bent relative to the floor panel (13b) and can be displaced from a flat rest position (FIG. 1) into an orthogonal use position (FIG. 9), and wherein shape-retaining formations (17a, 17b, 17c, 17d, 17e, 17f, 17g, 17h, 18a, 18b, 18c, 18d) are provided that are used to releasably lock a side-wall panel in its use position.

The invention relates to a pan for holding food according to the preamble of claim 1.

Pans for holding food of the generic type have been state of the art for hundreds, if not thousands, of years.

The invention relates in particular to a pan that is suitable for the baking and/or cooking of foodstuffs.

In particular, baking pans are known that are also referred to commercially as loaf pans. These generally consist of coated sheet metal parts that form a dimensionally stable, cuboid-shaped body. After baking, the pan has to be turned upside down in order to remove the cake.

To avoid turning upside down in this way, so-called spring-form pans are known at least for cylindrical baking pans with a circular cross-section.

The large amount of space needed to store these baking pans that in some cases are used only very occasionally but that regularly take up large volumes of space in kitchen cupboards, is problematic.

Furthermore, baking pans composed of silicone rubber have recently become known. These are rather low-volume baking pans that can take up less storage space thanks to the flexible and elastic properties of the material. The known silicone baking pans are dish-shaped and can be filled with the liquid cake batter, for example. The handling of these baking pans can cause problems owing to the flexibility of the wall regions.

Starting from the prior art described above, the object of the invention is to provide a pan that has a plurality of side walls and a floor, and the handling of which is improved.

The invention achieves this object with the features of claim 1, in particular with those of the characterizing portion, and is accordingly characterized in that the pan is formed from a flat mat consisting of a high-temperature-resistant, elastic, flexible silicone rubber or plastic, the mat comprising at least one floor panel and a plurality of side wall panels oriented parallel thereto, wherein between the floor panel and each side-wall panel an in particular straight predetermined fold line is arranged, along which the side wall can be bent relative to the floor panel and can be displaced from the flat rest position into an orthogonal use position, and wherein shape-retaining formations are provided that are used to releasably lock each side-wall panel in its use position.

The essential principle of the invention is explained as follows:

This is a pan in which foodstuffs can be accommodated. In particular, the pan is used for baking, in particular cakes, but similarly also for cooking, for example cooking pies. The invention also covers pans used to accommodate frozen products, for example for preparing a sorbet by a freezing process.

The pan in the assembled state, or with side walls in the use position, comprises a plurality of side walls, for example three, four or five side walls, and a floor. Thus, the pan has a cavity that can be filled with in particular a liquid or viscous or at least partially liquid product.

The pan according to the invention comprises a mat that is flat in the non-assembled state, composed of a particular material. In particular, the pan according to the invention comprises a mat composed of a high-temperature-resistant silicone rubber or of another suitable and comparable plastic. The material is designed to be high-temperature-resistant and is in particular capable of withstanding conventional oven temperatures of at least up to 250° C.—even repeatedly—without losing its flexible properties or, under the influence of temperature or in the event of a prolonged storage period, transferring any substances contained therein to the foodstuffs to be baked.

The pan according to the invention can be reused, and in particular can be reused many times.

The silicone rubber is elastic, in particular resilient to a certain extent, and also flexible. The material can therefore be for example folded up or pressed and rolled. To a small extent, the material can also be compressible.

The mat is substantially flat, so that all the sections, i.e. both the floor panel and the side-wall panels in rest position and the corner panels, which will be explained below, are oriented along a common plane. It is also covered by the invention if individual sections are to a slight extent oriented only substantially along a plane relative to other sections, for example as a result of persistent and frequent use, or form or exhibit waves, dents or the like.

According to the invention it is provided that, for example, the mat has a floor panel and four side-wall panels. If the pan is intended to form a substantially cuboid-shaped cavity with long side walls and short transverse side walls, the mat has a floor panel with two longitudinal side-wall panels and two transverse or widthwise side-wall panels.

According to the invention, a predetermined fold line is arranged between the floor panel and each side-wall panel. The predetermined fold line is in particular of straight configuration, and more particularly is configured along a straight line. It can be achieved for example by a material weakening.

For example, it can be provided according to the invention that the mat overall has a constant wall thickness or a substantially constant wall thickness of for example between 1 mm and 10 mm.

In the region of the predetermined bending points, the wall thickness can be configured to be smaller compared with the other sections of the mat.

The invention also covers for example embodiments in which the wall thickness of the mat is consistently about 2 mm to 4 mm, and is reduced in the region of the predetermined fold lines to wall thicknesses of between 0.5 mm and 1.5 mm.

On the one hand this enables the user to easily recognize the predetermined fold lines visually because the regions with reduced wall thickness stand out visually from the other sections, for example on the basis of contours or edges. Thus, the user is provided with an intuitive indication of the predetermined fold lines along which a displacement of a section relative to another section should be performed.

On the other hand, the bending process itself is made considerably easier.

Each side-wall panel can be bent relative to the floor panel along the respective predetermined fold line. Each side-wall panel can therefore be displaced from a flat rest position to an orthogonal or substantially orthogonal use position that is in particular at an angle of about 90° to the floor panel.

In the use position, the side-wall panel can be releasably locked, in particular relative to the adjacent side-wall panels, with the aid of shape-retaining formations. By transferring the bent side-wall panels from a flat mat into an orthogonal state and by locking them, a three-dimensional shape can be achieved that corresponds, for example, to a conventional loaf pan.

This shape is retained for as long as desired by the user.

Once the cake has finished baking—or the baking process or cooking process is complete—the shape-retaining formations can be released and the mat can be returned to its original flat state.

The cake can then be readily removed from the pan, specifically by folding the side-wall panels (viz. in particular all the side-wall panels) away from the cake and returning them to their planar rest position. The cake is then freely accessible from all five sides. It can also, for example, be iced directly on the mat, cut there or easily removed from the mat.

The same advantages are also offered to other dishes to be baked or cooked, such as for example pies or a frozen sorbet: releasing by turning the pan upside down is not necessary, since with the pan according to the invention the side walls can be folded away once the baking process is complete.

Once the baking or cooking process is complete, the mat can be easily cleaned. Because no corners remain, as is typical with conventional metallic loaf pans, cleaning can also be performed particularly easily with no effort.

Finally, with the pan according to the invention, the mat is suitable for placing in a dishwasher for cleaning purposes. Because of the flexible pan this can also be achieved in a space-saving and problem-free manner.

Once the cleaning process is complete, the mat can be permanently stored in a space-saving manner. To this end it can be for example rolled or folded or deformed in any manner, and only takes up very little space for its storage.

According to an advantageous embodiment of the invention, the mat is substantially rectangular in shape. This makes it extremely easy to prepare pans with cuboid-shaped cavities.

According to a further advantageous embodiment of the invention, the predetermined fold lines are achieved by areas with material weakenings. This allows the predetermined fold lines to be produced particularly easily.

According to a further advantageous embodiment of the invention, the mat has four side-wall panels that, in their orthogonal use position, form two longitudinal side walls and two transverse side walls. In this way, a baking or loaf pan can be made very easily.

According to a further advantageous embodiment of the invention, the mat has at its outside corners corner panels, each connecting two side-wall panels together. Each corner panel can in particular be made of two substantially triangular sub-sections. The corner panels particularly advantageously allow the arrangement of the shape-retaining formations, at least of some of the shape-retaining formations. In particular, by an appropriately optimized arrangement of the corner panels and the enabling of a folding process of the corner panels too, it is possible to achieve a liquid-tight connection between two adjacent side-wall panels in the use position.

According to a further advantageous embodiment of the invention, the corner panels also have predetermined fold lines. In particular the predetermined fold lines can be oriented along straight lines that divide the corner panel into two approximately equally sized, in particular substantially triangular, sub-sections.

According to a further advantageous embodiment of the invention the shape-retaining formations are fixed on the mat. This allows a pan to be prepared without the need for additional separate elements to achieve shape preservation.

According to a further advantageous embodiment of the invention, the shape-retaining formations each comprise a male connector or a projection and a recess or a plurality of recesses.

The invention covers in particular shape-retaining formations that are unitarily formed in the mat, i.e. in particular in one piece with a material bond. The shape-retaining formations can comprise for example male connectors that are broadened towards their free end and in particular broadened in a mushroom shape. These male connectors can cooperate with recesses. For example, a male connector can be arranged on a corner panel and can cooperate with a first recess that is likewise arranged on the corner panel, and with a second recess that is arranged on a side-wall panel. More particularly in this case, a retaining surface can be arranged on the male connector and an opposing retaining surface on the second recess. The male connector can, in the assembled state, engage through both recesses together. The recesses can in particular be in the form of edge recesses in the mat.

According to a further advantageous embodiment of the invention, the mat has stiffening elements in the region of the side-wall panels. For example, the stiffening elements can be made from plates formed using harder, in particular flexurally stiff, material such as for example metal. These can in particular be covered on both sides by the silicone rubber or the plastic material, and can be embedded in the material of the mat, so to speak, or overlain therewith.

Further advantages of the invention can be taken from the sub claims that are not cited, and from the following description of the embodiments illustrated in the drawing. The drawing shows the following:

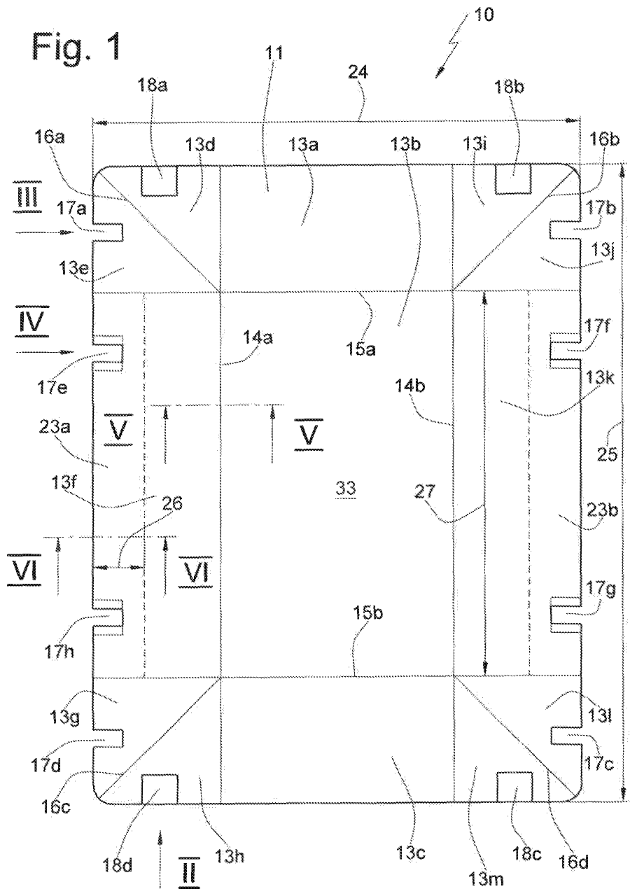

FIG. 1: in a partial cutaway, schematic top view a first embodiment of a pan according to the invention in the flat state as a mat,

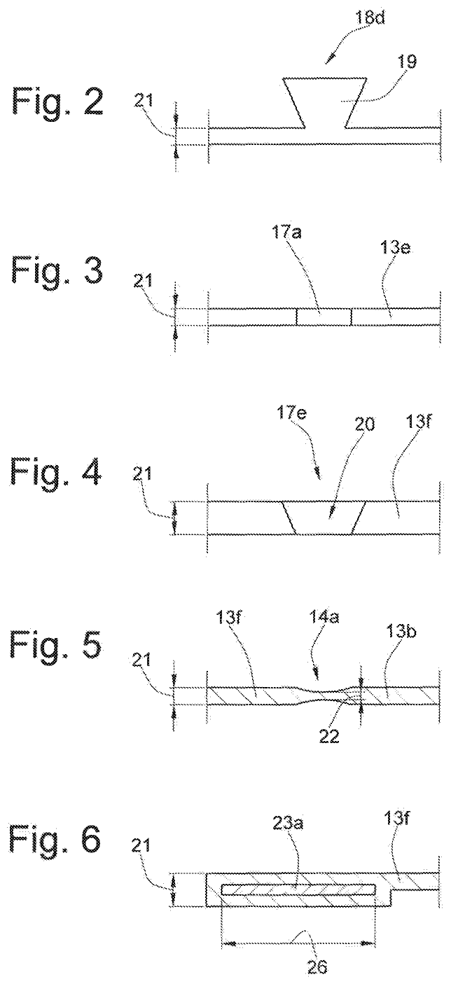

FIG. 2: in a partial cutaway schematic view a region of the pan of FIG. 1 with a shape-retaining formations provided by a male connector or a projection, for example along the arrow II in FIG. 1,

FIG. 3: a schematic view of part of a corner panel of the mat of FIG. 1, for example along arrow III in FIG. 1, illustrating a groove-shaped edge recess,

FIG. 4: in a schematic view according to arrow IV in FIG. 1 a region of the mat of FIG. 1, not shown to scale—with a recess having conical side walls,

FIG. 5: in a partial cutaway schematic view along section line V-V in FIG. 1 a section through the pan of FIG. 1, transverse to a predetermined bending line, illustrating a region of reduced wall thickness,

FIG. 6: in a partial cutaway schematic view a region of the pan of FIG. 1, for example along section line VI-VI, showing the stiffening element,

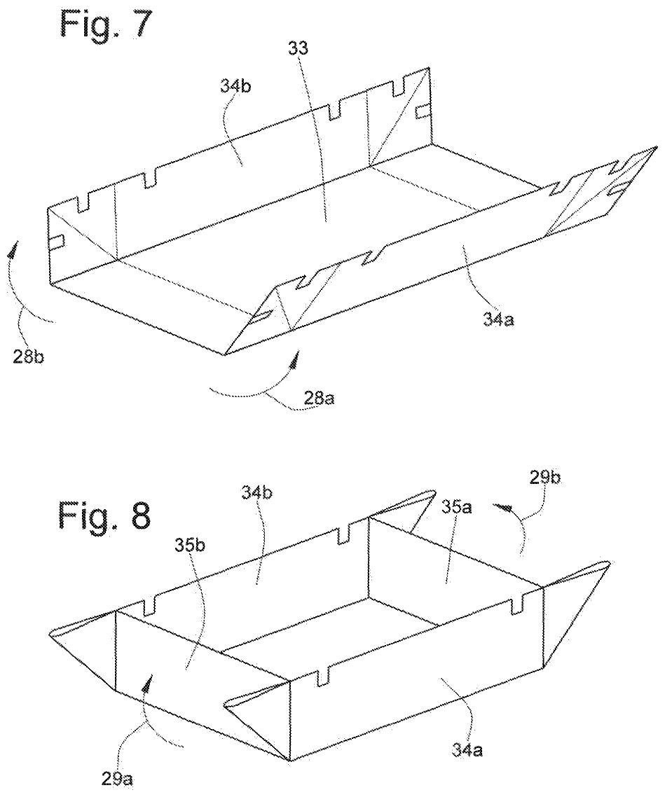

FIG. 7: in a perspective, schematic, simplified view, the pan of FIG. 1 with a first side wall in an orthogonal use position and an opposite side wall in an instantaneous state during the transfer from the rest position to its use position,

FIG. 8: the pan of FIG. 7 with all four side walls in an orthogonal use position,

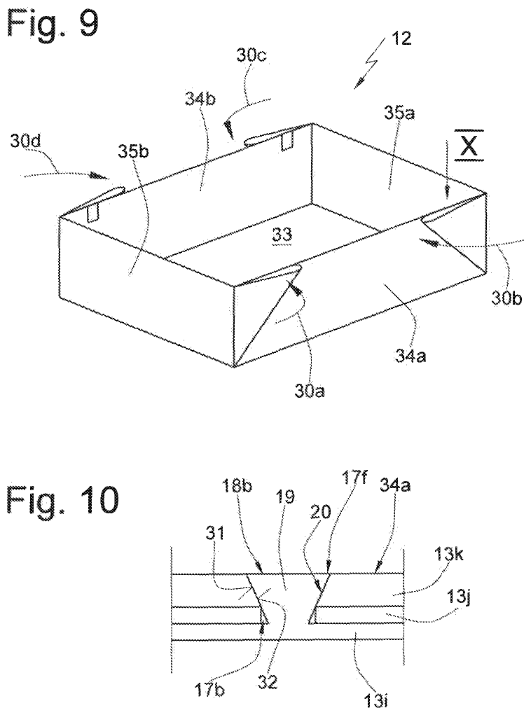

FIG. 9: the pan of FIG. 8 with corner panels displaced around their vertical axes,

FIG. 10: in a schematic, partial cutaway view the shape means of the pan in a locked position, for example along arrow X in FIG. 9, and

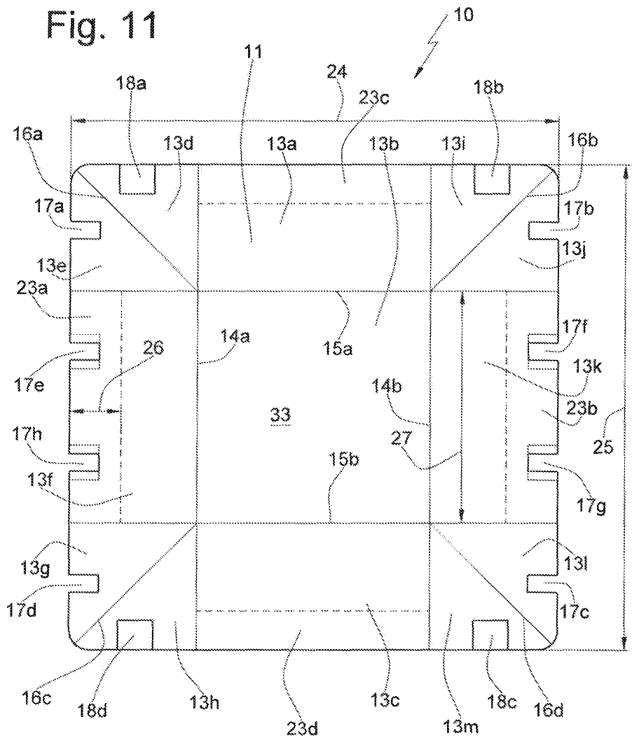

FIG. 11: in an illustration according to FIG. 1 a pan with modified length and width dimensions.

Embodiments of the invention are described by way of example in the following description of the figures that also refers to the drawings. For the sake of clarity, including where different embodiments are affected, identical or comparable parts or elements or regions are referred to by identical reference signs, with the addition of lower case letters in some cases.

Features that are described only in relation to one embodiment can also be provided in every other embodiment of the invention within the framework of the invention. Embodiments modified in this way are also covered by the invention, even if they are not shown in the drawings.

All disclosed features are in themselves essential to the invention. The disclosure content of the associated priority documents (copy of the prior application) and of the cited documents and prior art devices described is hereby incorporated in full into the disclosure of the present application, including for the purpose of incorporating individual or multiple features of these documents into one or more of the claims of the present application.

The pan referred to by the overall reference number 10 in the drawing will first be explained based on the illustration of FIG. 1:

In FIG. 1 a flat mat 11 can be seen that is also referred to as a flat blank.

From this, it is possible to construct a box pan 12 according to the illustration of FIG. 9, as will be explained in detail below.

It can be seen from FIG. 1 that the mat 11 has a plurality of sections 13.

In detail, the mat 11 first comprises a section 13b that is designed to provide a floor wall 33 for the box pan 12.

Furthermore the mat 11 comprises two side-wall panels 13k and 13f that in their use position provide longitudinal side walls 34a and 34b according to FIG. 9.

The mat 11 according to FIG. 1 further comprises side-wall panels 13a and 13c that in the orthogonal state provide transverse side walls 35a, 35b. The transverse side walls 35a, 35b can also be referred to as widthwise side walls.

Finally, the mat 11 also comprises a plurality of corner panels: thus, the mat 11 comprises corner panels 13i and 13j that are each substantially triangular in shape and that connect the side-wall panels 13a and 13k together.

The mat 11 also comprises corner panels 13l and 13m that connect the side-wall panels 13k and 13c together, and corner panels 13h and 13g that connect the side-wall panels 13c and 13f together, and finally corner panels 13d and 13e that connect the side-wall panels 13f and 13a together.

The mat 11 substantially has a constant wall thickness 21.

As can be seen in particular from the sectional illustration of FIG. 5, however, in the region of the predetermined bending points 14, 15, 16, sections with reduced wall thickness 22 are provided (see FIG. 5).

These predetermined bending lines or predetermined fold lines 14, 15, 16 are shown with solid lines in FIG. 1: thus, a first predetermined fold line 14a formed along a straight line is shown in the vertical direction, based on FIG. 1, and a second predetermined fold line 14b, oriented parallel thereto, is shown in FIG. 1.

The predetermined fold line 14a separates the side-wall panel 13f from the floor panel 33.

Similarly, the predetermined fold line 14b separates the side-wall panel 13k from the floor panel 33.

As a result of performing a bending operation, the corresponding side-wall panel 13k, 13f can be displaced by bending around the respective predetermined bending point 14a, 14b from the flat position shown in FIG. 1, the so-called rest position, as indicated in FIG. 7 by the bending direction arrows 28a and 28b, into their orthogonal position, the so-called use position, and in this way they form side walls 34a and 34b.

As can be seen in FIG. 1, the mat 11 additionally has predetermined fold lines 15a, 15b running horizontally based on FIG. 1. The predetermined fold line 15a separates the side-wall panel 13a from the floor wall section 33 and the predetermined fold line 15b separates the side-wall panel 13c from the floor panel 33.

The two side-wall panels 13c and 13a can similarly, as indicated in FIG. 8 by the bending direction arrows 29a and 29b, be displaced particularly easily in this way from the flat rest position according to FIG. 1 into their orthogonal use position according to FIG. 8 and in their use position they form side walls 35a and 35b.

The same predetermined fold line 14a additionally separates the corner panel 13d from the side-wall panel 13a. Similarly the predetermined fold line 15a also separates the corner panel 13e from the side-wall panel 13f.

Finally, the two corner panels 13e and 13d are also separated from each other by a diagonal predetermined fold line 16a.

The configuration is the same for the other three corner regions.

The diagonal predetermined fold lines 16a, 16b, 16c, 16d enable two mutually adjacent triangular corner panels to be folded towards each other in each case, as shown by FIG. 8.

FIG. 8 shows a situation in which these folded corner panels, folded into a triangular overall shape in each case, project outwards from the pan 12 in the direction of the longitudinal axes, forming a point.

Based on the arrangement of the predetermined fold lines 14a, 14b, 15a, 15b, starting from the position according to FIG. 8, these corner panels can now be folded over around a bending axis, that is oriented substantially vertically in each case based on FIG. 9, in such a way that they are each folded towards the respective longitudinal side wall 34a, 34b.

The locking of the side walls in their use position and the release thereof will be explained below:

As shown in FIG. 1, an edge recess 17a in the form of a receiving groove is provided in the region of the corner panel 13e.

A further recess 17e is provided in the adjacent side-wall panel 13f.

The receiving groove 17a, as can be seen for example from FIG. 3, is configured as a through-groove.

The recess 17e, on the other hand, as can be seen from the illustration of FIG. 4, is configured as a conical recess 20, i.e. as a receiving groove with conically tapering side walls.

On the corner panel 13d a locking element 18a is arranged that forms a shape-retaining formations within the meaning of the invention. FIG. 2 shows this shape-retaining formations in elevation view: it becomes clear that the shape-retaining formations comprises a locking projection 19 with a substantially trapezoidal cross-section that widens towards its free end.

The locking projection has an axial length, i.e. in the vertical direction based on FIG. 1 that corresponds to the axial length of the two grooves 17a and 17e, measured in the horizontal direction in FIG. 1. Moreover, the trapezoidal shape of the locking projection 19 is adapted to the conical trapezoidal cross-section of the conical recess 20.

Based on the illustration of FIG. 9 a state is reached in which the respective locking element 18a, 18b, 18c, 18d is aligned with the associated receiving grooves 17a, 17b, 17c, 17d, 17e, 17f, 17g, 17h.

Because of the flexibility of the material, the respective locking element 18a, 18b, 18c, 18d can be inserted by an axial movement, i.e. a movement transverse to the paper plane of FIG. 10—into both of the associated receiving grooves 17a, 17b, 17c, 17d, 17e, 17f, 17g, 17h.

FIG. 10 shows this locking state in a top view: the locking element 18b is seated with its locking projection 19 and its contact surfaces 31 in direct and complete contact with the opposing contact surfaces 32 of the conical recess 20. A positive fit between the section 13k and the section 13j therefore holds together these two sections together through the intermediary of the locking element 18b.

Since the section 13j is directly secured to the section 13i, a direct, positive connection between two mutually adjacent side walls 35a, 34a is achieved through the intermediary of the locking element 18b in each case.

The receiving groove 7b that is located between the two sections 13i and 13k in the folded state is penetrated by the respective locking element 18b.

It is of note that the two side-wall panels 13i and 13j, that are each folded towards each other to form a triangular section, form a pocket-like overlap, leading to a completely liquid-tight interior of the box pan 12. Liquid foodstuffs, including for example liquid cake batter, can therefore be poured in without the risk of liquid escaping from the pan 10.

After the cake has been baked or when the baking or cooking process is complete, the respective locking element 18a, 18b, 18c, 18d can be released from the two receiving grooves 17 in a geometrically opposite manner and the pan can be returned to a flat state.

The finished, baked cake is then freely accessible from the top, but also from all four side surfaces. It can, for example, be iced directly on the flat mat 11, or cut or removed. The mat 11 can then be easily cleaned.

As can be seen from FIGS. 1, 11 and 6, it is clear that reinforcing inserts 23a, 23b can be provided in the region of the side-wall panels 13f and 13k. These can have for example a width 26 and a length 27. In particular, the reinforcing inserts can be made of metal.

The length 27 of the reinforcing inserts can correspond to the corresponding length of the side-wall panel 13k.

It can be seen from FIG. 6 that the reinforcing inserts can be covered or overlain on all sides by plastic or silicone material. The reinforcing inserts increase the dimensional stability of the pan 10 in the assembled state.

The blank 11 of FIG. 1 has a length 25 and a width 24. In an alternative embodiment of the invention according to FIG. 11, the length 25 and the width 24 are the same, so that a substantially square mat 11 is obtained.

The number of reinforcing elements is arbitrary: for example, the mat 11 in FIG. 11 has a total of four reinforcing elements 23a, 23b, 23c, 23d.

The invention also relates to pans that are not illustrated that, instead of a rectangular mat 11, have triangular or polygonal cross-sections, or that have curved sections.

It is similarly covered by the invention if the mat 11 has a surface texture that has a structure and thus allows a certain embossing, for example in order to emboss contours or figures into the baked product.

Various suitable plastics can be considered as a material for the pan 12, in particular silicone rubber or other rubber-elastic materials. In particular here, it is possible to turn to materials that are already used in a conventional manner for baking pans and that are recommended or permitted by law for the baking or cooking of foodstuffs and the requirements.

For the sake of completeness, it should be noted that further embodiments of the invention not illustrated in the drawing comprise shape-retaining formations that are not connected to the mat 11 in one piece with a material bond, as in the embodiments illustrated in the drawing, but can be released from the mat. Thus, for example, annular or clip-like elements composed of rubber, metal or other suitable materials can be considered that ensure that the side walls remain in their orthogonal use position relative to the floor surface 33 during the baking or cooking process.

Furthermore, it should be pointed out that the embodiment of FIGS. 1 to 10 and the embodiment of FIG. 11 each show only a specific box pan in the form of a cuboid with specific predefined dimensions.

However, it is also possible and is covered by the invention that an embodiment of the invention, starting from a mat 11, enables the mat 11 to assume a first three-dimensional shape or a second one differing from the first at the user's discretion after the corresponding side wall region has been bent, owing to the presence of a plurality of groups of predetermined fold lines.

Thus, for example, it is possible that cuboids with different heights are achieved by folding different side-wall panels, as desired by the user, and transferring them into different three-dimensional shapes.

Furthermore, it should be noted at this point that, in addition to the embodiments of the drawings, i.e. the cuboid-shaped cavities illustrated, other three-dimensional shapes, for example circular cylindrical cavities, or spaces for holding food having, for example, a polygonal cross-section can be made.

It is also possible to provide curved wall surface sections, for example in order to form figurative representations.

The crucial factor is that the pan 10 according to the invention can be prepared from a flat blank 11 or a mat 11 by folding or bending operations, wherein the upwards-folded side walls can be fixed in their orthogonal use position for the duration of the baking or cooking process and the pan can be returned to its flat initial state after the baking or cooking process.

Instead of the shape-retaining formations described that provide a male-connector-like projection 19 and grooves 17 in the form of edge recesses, the invention also comprises in particular shape-retaining formations that are firmly connected to the mat 11 in one piece with a material bond and act in the manner of snap fasteners, and are pushed through openings in the corresponding wall regions of the side walls.

However, the shape-retaining formations 19, 20 shown in the embodiment offer the advantage that, in the locked state, the inside of the locking projections 19 are arranged flush with the insides of the side surfaces 34a, 34b. Thus, an attractive, continuous, smooth surface of the product to be baked, such as cake or bread, is achieved.

1. A pan for holding food for baking or cooking and having a plurality of side walls and a floor the pan being formed from a flat mat made of a high-temperature-resistant, elastic, flexible silicone rubber or another plastic, the mat being formed by
at least one floor panel and
a plurality of side-wall panels oriented parallel thereto,
a respective straight fold line between the floor and each side-wall panel and along which the respective side wall panel can be bent relative to the floor panel between a flat rest position and an orthogonal use position, and
shape-retaining formations that can releasably lock each side-wall panel in its use position.

2. The pan for holding food according to claim 1, wherein the mat is substantially rectangular in shape.

3. The pan for holding food according to claim 1, claim 1, wherein the fold lines are formed by linear areas with material weakening.

4. The pan for holding food according to claim 1, wherein the mat has four of the side-wall panels that in their orthogonal use position form two parallel longitudinal side walls and two parallel transverse side walls extending orthogonally between ends of the side-wall panels.

5. The pan for holding food according to claim 1, wherein the mat has outside corners each formed by respective pairs of corner panels that each connect two side-wall panels together.

6. The pan for holding food according to claim 5, wherein each pair of the corner panels has a respective central diagonal fold line.

7. The pan for holding food according to claim 1, wherein the shape-retaining formations are fixed on the mat.

8. The pan for holding food according to claim 1, wherein the shape-retaining formations each have a male connector or locking projection and a recess or a plurality of recess fittable complementarily with the respective projection.

9. The pan for holding food according to claim 1, wherein the mat has stiffening elements in each of the side-wall panels.

10. The pan for holding food according to claim 1, wherein each panel is substantially planar and in the rest position all the panels are coplanar.

11. The pan for holding food according to claim 5, wherein each of the corner panels is a right triangle and together each pair of corner panels forms a rectangle.
